(19) United States
(12) Patent Application Publication
(10) Pub. No.: US 2012/0185767 A1
(43) Pub. Date: Jul. 19, 2012

(54) MODIFYING APPLICATION BEHAVIOR

(75) Inventor: Eric Charles Schlegel, Redmond, WA (US)

(73) Assignee: APPLE INC., Cupertino, CA (US)

(21) Appl. No.: 13/166,764

(22) Filed: Jun. 22, 2011

Related U.S. Application Data
(60) Provisional application No. 61/433,187, filed on Jan. 14, 2011.

(51) Int. Cl. G06F 17/24

(52) U.S. Cl. 715/255

(57) ABSTRACT

Methods, systems, and apparatus, including computer programs encoded on a computer storage medium, for modifying application behavior. In one aspect, a method includes receiving, from an application, a command to present an element of a graphical user interface. One or more previously received commands is received from the application. An operation that should be performed on a document is identified. The operation is performed instead of presenting the element of the graphical user interface.

### CROSS-REFERENCE TO RELATED APPLICATIONS

This application claims the benefit under 35 U.S.C. §119(e) of U.S. Provisional Application Ser. No. 61/433,187, filed on Jan. 14, 2011 entitled “Modifying Application Behavior,” the entirety of which is hereby incorporated by reference.

### BACKGROUND

This specification relates to document management. Conventional operating systems manage and store documents in a file system. Documents can be edited and saved by applications.

### SUMMARY

This specification relates to technologies relating to managing documents.

Versions of applications, in particular third party applications, can have internal logic and behavior that cannot be changed by developers of the operating system on which the applications depend. In response to some user actions, an application can request input from the user, for example, through a presentation of a particular graphical user interface (“GUI”) element (e.g. a save dialog box). Instead of presenting the GUI element, the operating system can intercept the request to generate the GUI element and automatically perform a responsive action. For example, the operating system can intercept the request to present a save dialog box, automatically save the document to file, and return control to the application as if the save dialog box had been successfully presented.

In general, one innovative aspect of the subject matter described in this specification can be embodied in methods that include the actions of receiving, from an application, a command to present an element of a graphical user interface; identifying one or more previously received commands from the application; determining that an operation should be performed on a document; and performing the operation instead of presenting the element of the graphical user interface. Other embodiments of this aspect include corresponding systems, apparatus, and computer programs, configured to perform the actions of the methods, encoded on computer storage devices.

These and other embodiments can each optionally include one or more of the following features. Performing the operation includes saving the document. Saving the document includes writing the document to a file. The element of the graphical user interface is a save dialog box. A response is provided to the application that the element was successfully presented. A second operation is performed on the document after the application is reopened. Performing the operation includes providing instructions to the application with a scripting interface. Determining that the operation should be performed is based on attributes of the document and the application. Determining that the operation should be performed includes determining that the document is not a read-only document.

Another innovative aspect of the subject matter described in this specification can be embodied in methods that include the actions of receiving, from a process, a request to read a file corresponding to a document open in an application; determining that the document has been modified since a time that the document was most recently saved; issuing a command to the application to save the document; and after the document has been saved, providing read access to the process. Other embodiments of this aspect include corresponding systems, apparatus, and computer programs, configured to perform the actions of the methods, encoded on computer storage devices.

Particular embodiments of the subject matter described in this specification can be implemented so as to realize one or more of the following advantages. Users can work on and edit a document over multiple application sessions without ever manually saving the document or interacting with a save dialog box. Information losses from unsaved changes are reduced. Other processes can read up-to-date versions of documents that have not yet been saved by the user. The operating system can enhance functionality of applications by providing access to prior versions of manually and automatically saved documents.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic diagram of an example system for document management of applications.

FIG. 2 is a flow chart of an example process for automatically saving a new document.

FIG. 3 is a flow chart of an example process for automatically saving an edited document.

FIG. 4 is a flow chart of an example process for determining whether a document should be automatically saved.

FIG. 5 is a flow chart of an example process for automatically saving a document before being read by another process.

FIG. 6 is a flow chart of an example process for automatically saving persistent copies of a document.

FIG. 7 illustrates an example architecture of a system.

Like reference numbers and designations in the various drawings indicate like elements.

### DETAILED DESCRIPTION

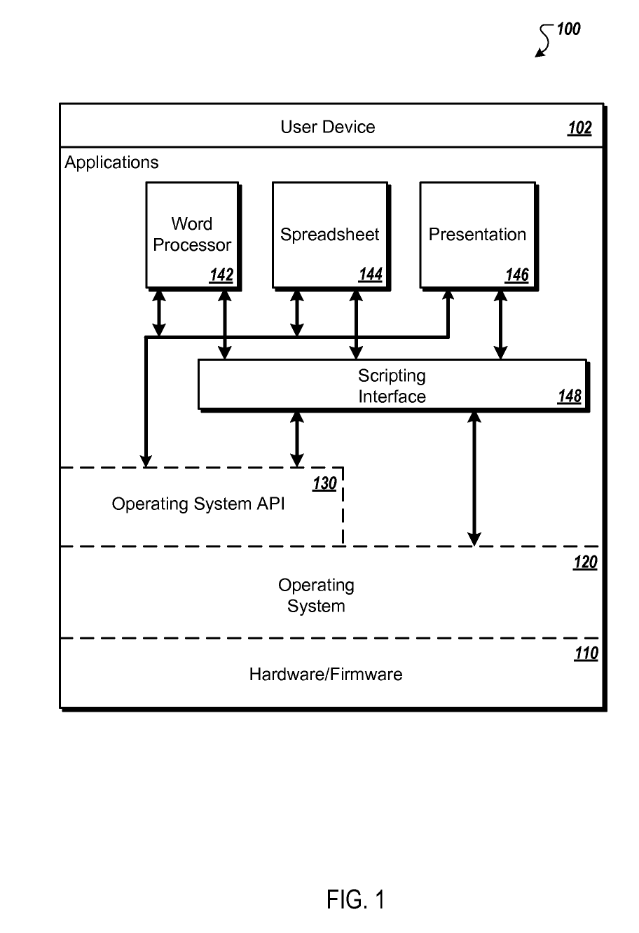

FIG. 1 is a schematic diagram of an example system 100 for modifying application behavior. The system 100 includes a user device 102. The user device 102 includes one or more data processing apparatus of the hardware/firmware 110. The user device can include various modules, e.g. executable software programs, including a word processor application 142, a spreadsheet application 144, a presentation application 146, and a scripting interface 148.

The user device 102 includes an operating system 120. The operating system (“OS”) includes an application programming interface (“API”) that provides an interface between applications running on the user device (e.g., word processor 142, spreadsheet application 144, or presentation application 146) and the operating system 120. The operating system implements a file system (not shown) for storing electronic files.

Each module runs, for example, as part of the operating system on the user device 102, as an application on the user device 102, or as part of the operating system 120 and part of an application on the user device 102. Although several software modules are illustrated, there may be fewer or more software modules. Moreover, the software modules can be distributed on one or more data processing apparatus connected by one or more networks or other suitable communication mediums.

A user can interact with the applications (e.g., as provided by the software modules), for example, to create and modify electronic documents. An electronic document (which for brevity will simply be referred to as a document) may, but need not, correspond to a file. A document may be stored in a portion of a file that holds other documents, in a single file dedicated to the document in question, or in multiple coordinated files. A document can be stored in memory without having first been stored in a file.

An API is a set of conventions that provide interactivity between software modules. A particular OS API provides applications the ability to interact with the operating system in a consistent way. In response to an API call, the operating system provides a response back to the application. The response may indicate that the API call was successful or unsuccessful. Example functions of the OS API 130 include creating files, saving files, deleting files, creating directories, deleting directories, etc. Although the user device 102 is shown with only one OS API 130, an operating system may have multiple APIs, which may be implemented in one or more layers. Some OS APIs are object-oriented. Software modules can interact directly with the OS API 130. Software modules can also interact with the operating system through a scripting interface 148 or a combination of the OS API 130 and the scripting interface 148.

The scripting interface 148 is a software module that implements a scripting language. A scripting language is a programming language allows control of other software applications. Unlike an API, a scripting interface can be altered (by e.g., editing a script) after a software module has already been implemented and installed. The scripting interface thus allows the behavior of applications to be altered. A software module that supports scripting language interactivity can take advantage of the scripting interface. In some implementations, scripting language support is provided by an application API (not shown). Example application API functionality includes saving a document, creating a document, or editing a document.

The scripting interface 148 provides interactivity between the operating system and applications that support the scripting interface 148. The scripting interface 148 can interact with the operating system 120 through the OS API 130, or the operating system 120 can interact with the scripting interface 148 directly.

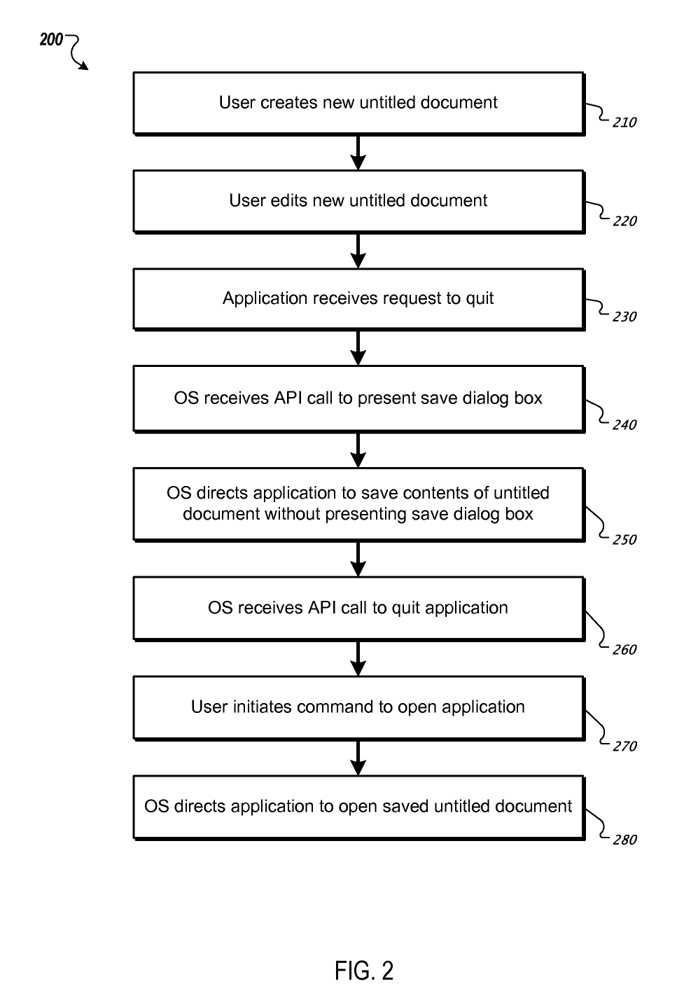

FIG. 2 is a flow chart of an example process 200 for automatically saving a new document. The process includes actions performed by an operating system (e.g. operating system 120) in response to actions taken by a user of an application. Actions taken by the user of an application can result in the application making calls to the OS API. In general, the operating system can monitor sequences of OS API calls and use a scripting interface (e.g. scripting interface 148) to alter the management of documents associated with the calls by the application.

A user creates a new untitled document (210). The document may be any of a variety of document types, e.g. a word processing document, a spreadsheet document, or a presentation document. In some implementations, creating a new document includes an OS API call to reserve storage device space for one or more new files corresponding to the document. In some other implementations, a file corresponding to the new document is not created until the document is saved.

A user edits the new document (220). After a user edits a document, an application typically does not automatically save the edited version of the document to a file. Furthermore, a file corresponding to the document may not exist.

The application receives a request to quit (230). The request to quit an application can either be initiated from within the application itself (e.g., a menu item within an application user interface), or initiated from an operating system user interface element (e.g., closing a window). The request to quit can additionally come from another process (e.g., on system shutdown or from a process manager application). On receiving the request to quit, applications can recognize that the new document created in step 210 has not been saved and will seek user input regarding the unsaved document before issuing operating system commands to quit the application.

The operating system receives an API call from the application to present a save dialog box (230). In some implementations, a save dialog box is an element of a graphical user interface that provides multiple options for how the user would like to handle the unsaved document. The options can include “save,” to save the document; “cancel,” to abort the quit command and keep the application open; or “discard,” to quit the application without saving the document. In some implementations, the operating system examines the contents of the dialog box being presented to determine what type of dialog box is being presented. For example, the operating system can determine that “save,” “cancel,” and “discard,” options were to be presented to the user, and as a result, determine that the application requested a save dialog box to be presented.

The operating system directs the application to save the contents of the untitled document without presenting the save dialog box (250). If the operating system determined that a save dialog box was to be presented (by, e.g., examining the contents of the dialog box), the operating system can alter the application's default behavior for the untitled document. Instead of presenting a save dialog box to the user, the operating system directs the application to save the document instead. Thus, the document is saved without a prompt to the user being displayed and acted upon by the user. In some implementations, the operating system uses a scripting interface to direct an application to save the untitled document with a specific filename and location. In some other implementations, the operating system saves the document directly. The operating system can provide the application a response through the API indicating that the save dialog box call was successful, and that the document was saved with the given filename and location. Alternatively, the operating system can also provide the application a response indicating user input in the dialog box to save the document. The operating system can automatically save multiple untitled documents. In some implementations, the operating system maintains a data structure storing a path to each untitled document that was automatically saved.

The operating system receives an API call to quit the application (260). After receiving a successful response to the API call for presenting a save dialog box, the application can call an OS API to quit the application. The operating system, in response to the OS API call to quit the application, can free memory previously allocated to that application. Additional clean-up operations, e.g. deleting temporary files, can also be performed by the operating system in response to an OS API call to quit an application.

The user initiates a command to open the application (270). The user can initiate a command to open the application by interacting with one or more elements of a graphical user interface (e.g., an icon or menu) or by issuing a command on a command-line prompt.

The operating system directs the application to open the saved untitled document (280). Instead of launching the application with a blank untitled document (or no document), the operating system uses the scripting interface to direct the application to open the saved document. The operating system can iterate over all untitled documents that have been saved automatically and can direct the application to open each saved untitled document when the application is opened.

In some implementations, the opened document is untitled. The opened document can be opened as untitled rather than opened with its operating system filename, which need not be “untitled.” In some other implementations, the opened document has an automatically assigned filename (e.g., a timestamp). The operating system can monitor API calls from the application to determine that a document should be opened as an untitled document, rather than opened with its operating system filename. After the application opens a document, the application can make an API call to the operating system to request a file reference for the document. The request for a file reference can contain a window identifier and a file path. If the file path matches one of the untitled documents that has been automatically saved, the operating system can determine that the document should be opened as an untitled document. In some implementations, the operating system attaches a special data structure to the window of the open document to indicate that the window contains an untitled document that should be automatically saved.

To the user, the unsaved document is automatically restored from its previous version without the user saving or interacting with a save dialog box. To the application, a save dialog box was presented, the file was saved, and the file was subsequently opened. The operations of bypassing a request for interaction from a user and instead saving a document will be referred to as “autosave.”

In some implementations, the process of FIG. 2 can be repeated multiple times, so that the user can open and close the application repeatedly while working on the same document without ever interacting with a save dialog box. The saved document can be opened instead of a blank untitled document even when other documents are opened or created before the application is re-launched.

In some implementations, once an untitled document is automatically saved, the document will thereafter be automatically saved before the document or application is closed. The operating system can use the special data structure attached to the window of an open document to determine that the document is an untitled document that should be automatically saved.

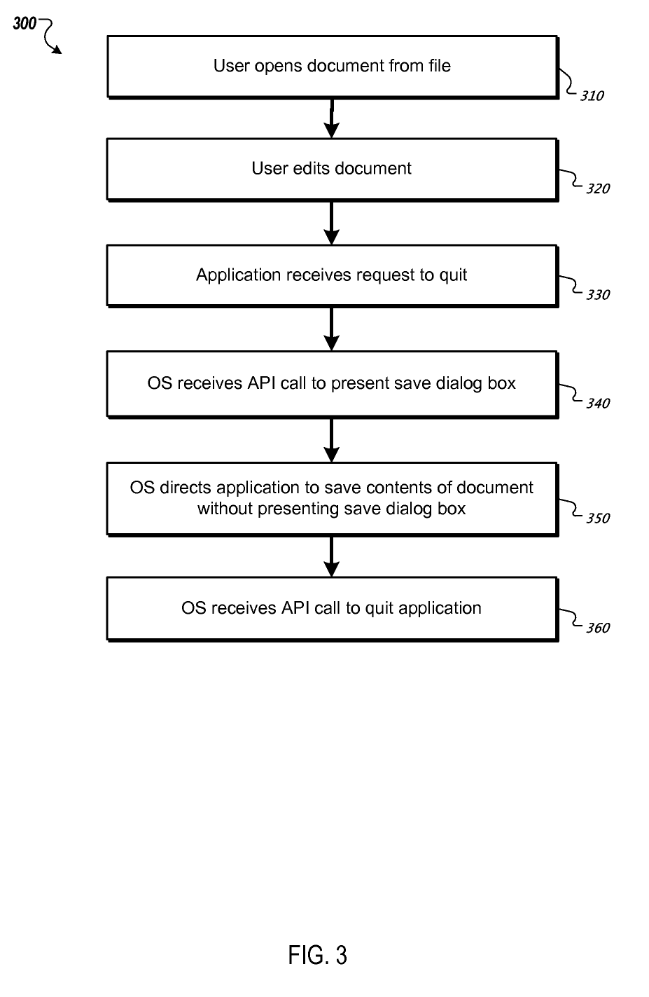

FIG. 3 is a flow chart of an example process 300 for automatically saving an edited document.

A user opens a document from a file (310). The user edits the open document (320). Editing a document within an application causes the open document to differ from the version saved in the file system. The user can be the same individual or any user of a particular account or application session.

The application receives a request to quit (330). The request to quit can either be initiated from within the application itself, from interaction with an operating system element, or from another process. On receiving the request to quit, applications can detect that the document has been modified since the last time the document has been saved. In some implementations, the application seeks user input regarding the unsaved changes.

The OS receives an API call to present a save dialog box (330). In response to the API call to present the save dialog box, the OS directs the application to save the contents of the document without presenting the save dialog box (340). The OS can save the document with its current filename and location, or the OS can save the document with a temporary or new filename and location. After saving the document, the OS can provide the application a response indicating that the save dialog box was successfully presented and that a save document input was received. In some implementations, the OS directs the application to save all open documents.

The OS receives an API call to quit the application (350). The OS quits the application normally. In some implementations, a document that was automatically saved can be automatically opened the next time the application is launched.

In some implementations, an application quits without seeking user input regarding unsaved changes. In these cases, the OS can automatically save the document before quitting the application.

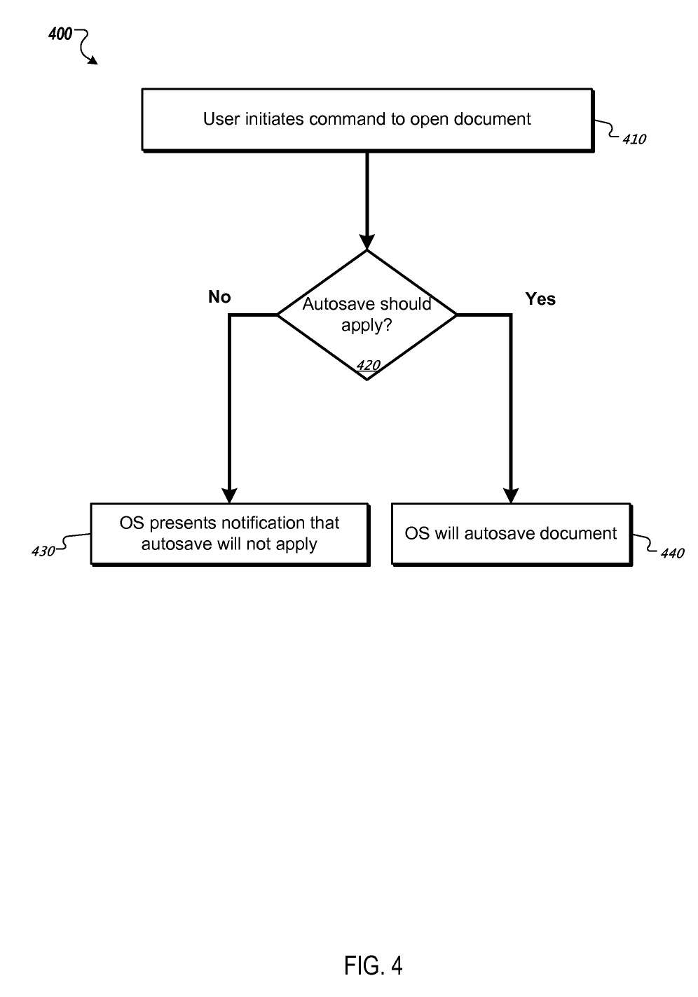

FIG. 4 is a flow chart of an example process 400 for determining whether a document should be automatically saved. Automatic saving of a document is not the preferred behavior in all circumstances. The OS will first determine whether the automatic saving functionality should apply before performing automatic saving, e.g. as shown FIG. 2 and FIG. 3.

A user initiates a command to open a document (410). The user can open a document by either using the internal functionality of an application or by interacting with an icon representing the document (e.g., double-clicking) in a graphical user interface of the operating system.

The OS determines whether the document should be autosaved (420). The OS can use attributes of the document itself, as well as attributes of the application associated with the document. Various situations will cause the OS not to autosave the document.

For example, if the application corresponding to the document does not support a scripting interface (e.g. scripting interface 148 of FIG. 1), the OS should not perform autosave functionality.

In some implementations, the OS determines that a document should not be autosaved because it has not been recently modified. Edits to a document that has not been recently modified can be accidental, and therefore will not warrant autosave functionality.

In some other implementations, the OS determines that a document should not be autosaved because it is read-only or locked. A read-only document can be read by a user of the operating system, but cannot be edited or deleted. A locked document can be reserved for editing, either by another user or by another process. In such cases, the OS can determine that autosave functionally should not apply.

In some other implementations, the OS determines that a document should not be autosaved because it is located in a special directory. Certain directories may be identified by the OS as directories where documents should not be autosaved.

If autosave should not apply, the OS presents a notification that autosave will not apply (430). In some implementations, the notification is displayed in a dialog box when the application opens so that a user will know that the current document must be manually saved. In some implementations, a document that is read-only is saved into a new, editable document for which autosave applies. Thereafter, the operating system will perform autosave functionality for the newly saved document. In some other implementations, a document that is locked can be unlocked. After unlocking, the operating system can perform autosave functionality for the newly unlocked document.

If autosave should apply, the OS will autosave the document (440). For example, the OS can autosave the document as described above with respect to FIG. 2 and FIG. 3.

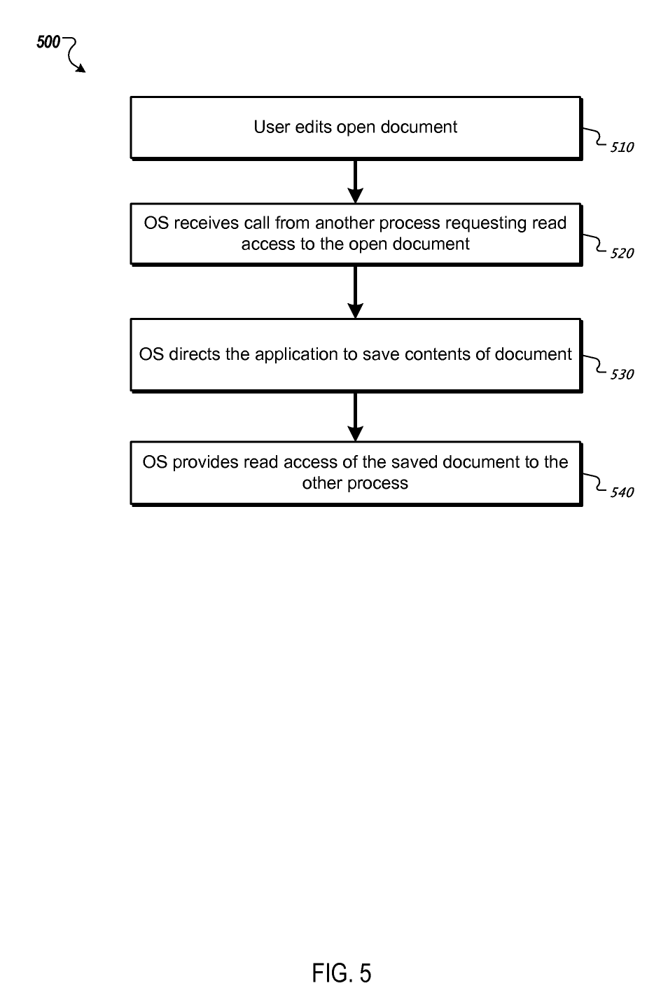

FIG. 5 is a flow chart of an example process 500 for automatically saving a document before being read by another process. Multiple processes can read the contents of documents stored in a file system. A process can read the contents of a document while the document is currently being edited in an application running in a different process. In many situations, the version of the document stored in a file differs from the version of the document as opened in an application.

A user edits an open document (510). The edits cause the version of the document stored as a file of the file system to differ from the version as open in the application.

The OS receives a call from another process requesting read access to the document (520). The OS can determine that the document has been edited in the application before the other process attempted to read the document. The process requesting read access can be a different process than the process or processes currently running the application.

The OS directs the application to save the contents of the document (530). In some implementations, the OS uses a scripting interface (e.g. scripting interface 148 of FIG. 1) to direct the application to save the contents of the document. In response, the application can make an OS API call to write the contents of the open document to file. The OS can receive the call to write the contents of the document to file and save the updated document to a file in a file system.

The OS provides read access of the saved document to the other process (540). After directing the application to save the open document, the other process can read a copy of the document that matches the document open in the application.

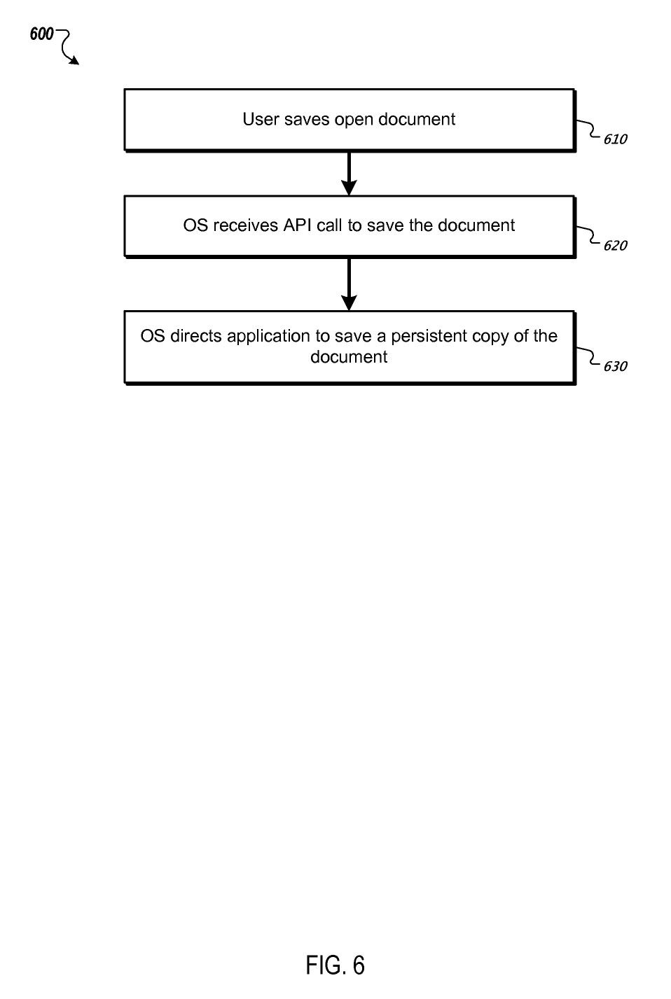

FIG. 6 is a flow chart of an example process for automatically saving persistent copies of a document. Persistent copies of a document can be stored so that they last longer than the processes that created them. Persistent copies can be retrieved by another process after the original process ends. Persistent files can be stored, for example, on a hard disk. Automatically saving persistent copies of a document can allow users to retrieve multiple prior versions of a document.

A user saves an open document (610). In some implementations, saving a document includes clicking a “save” icon in the application that opened the document. In some other implementations, a user can save a document by a keyboard command. Other methods for issuing save commands are possible.

The operating system receives an API call to save the document (620). In some implementations, the API call directing the operating system to save a document includes a command to write document data to a file of the file system.

The operating system directs the application to save a persistent copy of the document (630). In some implementations, the OS uses a scripting interface (e.g., scripting interface 148 of FIG. 1) to direct the application to save the contents of the document. The operating system can specify custom filenames and locations for the persistent copy. In some implementations, the persistent copies created are not visible to a user of the operating system's file system.

After saving one or more persistent copies of a document, the operating system can provide the user the ability to retrieve any previously saved versions of the document. In some implementations, a special user interface is displayed to allow the user to select which prior version of the document to retrieve.

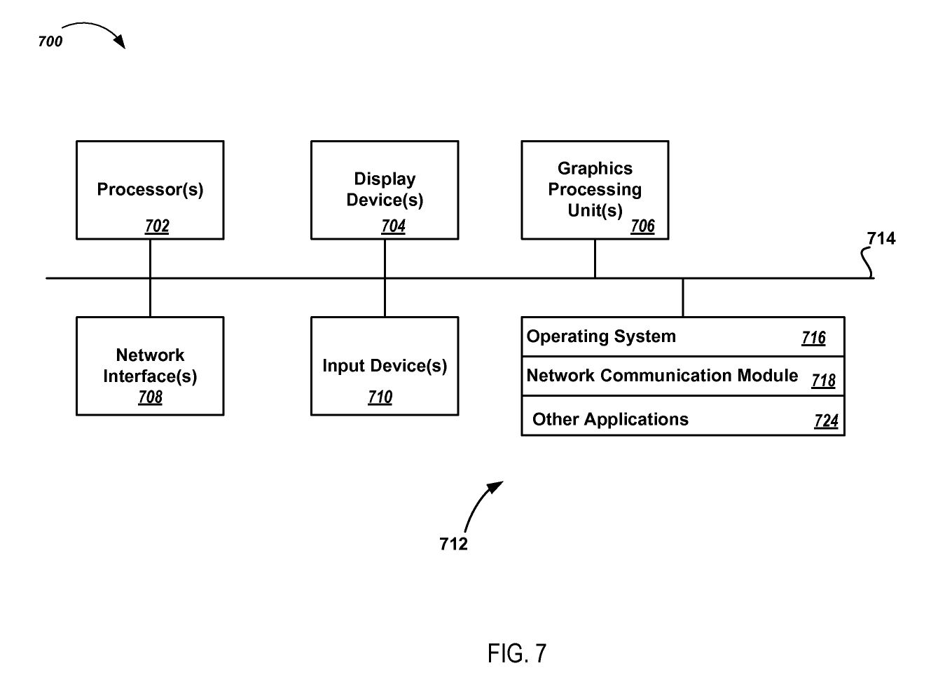

FIG. 7 illustrates an example architecture of a system 700. The system architecture 700 is capable of performing operations for performing file system management. The architecture 700 includes one or more processors 702 (e.g., IBM PowerPC, Intel Pentium 4, etc.), one or more display devices 704 (e.g., CRT, LCD), graphics processing units 706 (e.g., NVIDIA GeForce, etc.), a network interface 708 (e.g., Ethernet, FireWire, USB, etc.), input devices 710 (e.g., keyboard, mouse, etc.), and one or more computer readable mediums 712. These components exchange communications and data using one or more buses 714 (e.g., EISA, PCI, PCI Express, etc.).

The term “computer-readable medium” refers to any medium that participates in providing instructions to a processor 702 for execution. The computer-readable medium 712 further includes an operating system 716 (e.g., Mac OS®, Windows®, Linux, etc.), a network communication module 718, and other applications 724.

The operating system 716 can be multi-user, multiprocessing, multitasking, multithreading, real-time and the like. The operating system 716 performs basic tasks, including but not limited to: recognizing input from input devices 710; sending output to display devices 704; keeping track of files and directories on computer-readable mediums 712 (e.g., memory or a storage device); controlling peripheral devices (e.g., disk drives, printers, etc.); and managing traffic on the one or more buses 714. The network communications module 718 includes various components for establishing and maintaining network connections (e.g., software for implementing communication protocols, e.g., TCP/IP, HTTP, Ethernet, etc.).

The operating system 716 provides various software components for performing the various functions for modifying application behavior for third-party applications as described with respect to FIGS. 1-5.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method comprising:
receiving, from an application, a command to present an element of a graphical user interface;
identifying one or more previously received commands from the application;
determining that an operation should be performed on a document; and
performing the operation instead of presenting the element of the graphical user interface.

2. The method of claim 1, wherein performing the operation comprises saving the document.

3. The method of claim 2, wherein saving the document comprises writing the document to a file.

4. The method of claim 2, wherein the element of the graphical user interface is a save dialog box.

5. The method of claim 1, further comprising:
providing a response to the application that the element was successfully presented.

6. The method of claim 5, further comprising:
performing a second operation on the document after the application is reopened.

7. The method of claim 1, wherein performing the operation comprises providing instructions to the application with a scripting interface.

8. The method of claim 1, further comprising:
determining that the operation should be performed based on attributes of the document and the application.

9. The method of claim 8, wherein determining that the operation should be performed comprises determining that the document is not a read-only document.

10. A method comprising:
receiving, from a process, a request to read a file corresponding to a document open in an application;
determining that the document has been modified since a time that the document was most recently saved;
issuing a command to the application to save the document; and
after the document has been saved, providing read access to the process.

11. The method of claim 10, wherein the process is a different process than a process running the application.

12. The method of claim 10, further comprising:
after issuing a command to the application to save the document, receiving a corresponding request from the application to write the contents of the document to a file.

13. The method of claim 10, wherein issuing a command to the application to save the document comprises providing instructions to the application using a scripting interface.

14. The method of claim 10, wherein after the document has been saved, contents of the document as open in the application match contents of the document as stored in a file.

15. A system comprising:
one or more computers; and
a computer-readable storage device having stored thereon instructions that, when executed by the one or more computers, cause the one or more computers to perform operations comprising:
receiving, from an application, a command to present an element of a graphical user interface;
identifying one or more previously received commands from the application;
determining that an operation should be performed on a document; and
performing the operation instead of presenting the element of the graphical user interface.

16. The system of claim 15, wherein performing the operation comprises saving the document.

17. The system of claim 16, wherein saving the document comprises writing the document to a file.

18. The system of claim 16, wherein the element of the graphical user interface is a save dialog box.

19. The system of claim 15, wherein the operations further comprise:
providing a response to the application that the element was successfully presented.

20. The system of claim 19, wherein the operations further comprise:
performing a second operation on the document after the application is reopened.

21. The system of claim 15, wherein performing the operation comprises providing instructions to the application with a scripting interface.

22. The system of claim 15, wherein the operations further comprise:
determining that the operation should be performed based on attributes of the document and the application.

23. The system of claim 22, wherein determining that the operation should be performed comprises determining that the document is not a read-only document.

24. A system comprising:
one or more computers; and
a computer-readable storage device having stored thereon instructions that, when executed by the one or more computers, cause the one or more computers to perform operations comprising:
receiving, from a process, a request to read a file corresponding to a document open in an application;
determining that the document has been modified since a time that the document was most recently saved;
issuing a command to the application to save the document; and
after the document has been saved, providing read access to the process.

25. The system of claim 24, wherein the process is a different process than a process running the application.

26. The system of claim 24, further comprising:
after issuing a command to the application to save the document, receiving a corresponding request from the application to write the contents of the document to a file

27. The system of claim 24, wherein issuing a command to the application to save the document comprises providing instructions to the application using a scripting interface.

28. The system of claim 24, wherein after the document has been saved, contents of the document as open in the application match contents of the document as stored in a file.

29. A computer-readable storage device having stored thereon instructions, which, when executed by a computer, cause the computer to perform operations comprising:
receiving, from an application, a command to present an element of a graphical user interface;
identifying one or more previously received commands from the application;
determining that an operation should be performed on a document; and
performing the operation instead of presenting the element of the graphical user interface.

30. The storage device of claim 29, wherein performing the operation comprises saving the document.

31. The storage device of claim 30, wherein saving the document comprises writing the document to a file.

32. The storage device of claim 30, wherein the element of the graphical user interface is a save dialog box.

33. The storage device of claim 29, wherein the operations further comprise:
providing a response to the application that the element was successfully presented.

34. The storage device of claim 33, wherein the operations further comprise:
performing a second operation on the document after the application is reopened.

35. The storage device of claim 29, wherein performing the operation comprises providing instructions to the application with a scripting interface.

36. The storage device of claim 29, wherein the operations further comprise:
determining that the operation should be performed based on attributes of the document and the application.

37. The storage device of claim 36, wherein determining that the operation should be performed comprises determining that the document is not a read-only document.
